(19) United States
(12) Patent Application Publication
(10) Pub. No.: US 2014/0247622 A1
(43) Pub. Date: Sep. 4, 2014

(54) HEAT DISSIPATION STRUCTURE OF TABLET DISPLAY MEMBER

(71) Applicant: CHE-YUAN WU, NEW TAIPEI CITY 251 (TW)

(72) Inventor: CHE-YUAN WU, NEW TAIPEI CITY 251 (TW)

(21) Appl. No.: 13/903,175

(22) Filed: May 28, 2013

(30) Foreign Application Priority Data
Mar. 4, 2013 (TW) 102203949

(51) Int. Cl. F21V 8/00

(52) U.S. Cl. CPC G02B 6/0085
USPC 362/613; 362/97.1; 362/611

(57) ABSTRACT

A heat dissipation structure of tablet display member, which is applicable to an electronic product. The heat dissipation structure includes: at least one heat conduction plate assembly partially positioned beside a light source assembly of the display member, the heat conduction plate assembly having a heat conduction face adjacent to the light source assembly; and a heat spreader able to quickly transversely conduct heat. The heat spreader is attached to the heat conduction plate assembly. The heat spreader has a proximal-to-heat-source section proximal to the light source assembly and a distal-from-heat-source section distal from the light source assembly. The heat conduction plate assembly and the heat spreader cooperate with each other to conduct and spread the heat of the heat source in different directions so as to uniformly dissipate the heat and avoid accumulation of the heat around the heat source.

### BACKGROUND OF THE INVENTION

1. Field of the Invention

The present invention relates generally to a heat dissipation structure of tablet display member, and more particularly to a heat dissipation structure, which is applicable to a display member for quickly and uniformly dissipating the heat generated by the light source assembly of the display member so as to avoid accumulation of the heat and abnormal rise of the temperature of the display member.

2. Description of the Related Art

The conventional backlight module applied to the (liquid crystal) screen of an electronic product basically includes at least one light guide plate and multiple light sources arranged on a part of the periphery of the light guide plate. (The light sources are generally cold-cathode tubes or light-emitting diodes). The light guide plate serves to uniformly spread the light emitted from the light sources to form a backlight beam as a face light source. Along with the gradual enlargement of the size of the (liquid crystal) screen, the number of the light sources is gradually increased and the power of the light sources is gradually enhanced. As a result, the heat generated by the light sources will inevitably increase. The heat must be efficiently dissipated outward by means of heat dissipation device and isolated. Otherwise, the heat will accumulate around the light sources to cause abnormal rise of the temperature of a local part of the periphery of the (liquid crystal) screen. This not only will affect the function of the electronic product, but also will shorten the lifetime of the relevant components.

It is therefore tried by the applicant to provide a heat dissipation structure of tablet display member to overcome the above problems.

### SUMMARY OF THE INVENTION

It is therefore a primary object of the present invention to provide a heat dissipation structure of tablet display member, which is able to quickly spread and outward dissipate the heat generated by the light source assembly of the display member so as to avoid concentration of the heat and abnormal rise of the temperature of a local part of the display member.

It is a further object of the present invention to provide the above heat dissipation structure of tablet display member, in which no expensive heat conduction component is used so that the manufacturing cost of the heat dissipation structure is lowered to promote the economic efficiency.

To achieve the above and other objects, the heat dissipation structure of tablet display member of the present invention includes: at least one backlight module having a light source assembly, the light source assembly being at least partially disposed on a periphery of a panel (liquid crystal panel); at least one heat conduction plate assembly having at least one electroconductive heat conduction plate; and at least one heat spreader, which is able to quickly conduct heat along the surface, the heat spreader being attached to and in contact with the heat conduction plate assembly, the heat spreader having a proximal-to-heat-source section proximal to the light source assembly and a distal-from-heat-source section distal from the light source assembly, at least one of the heat conduction plate assembly and the heat spreader having a heat conduction face adjacent to the light source assembly.

In the above heat dissipation structure of tablet display member, the heat conduction plate assembly includes at least two heat conduction plates. The heat spreader is disposed between the heat conduction plates in contact with the heat conduction plates.

In the above heat dissipation structure of tablet display member, the heat conduction plates of the heat conduction plate assembly have equal size and identical shape.

In the above heat dissipation structure of tablet display member, the heat spreader has an area smaller than that of the heat conduction plates.

In the above heat dissipation structure of tablet display member, the heat spreader is an elongated plate body.

In the above heat dissipation structure of tablet display member, the heat spreader has an elongated main extension section and at least one branch section obliquely extending from one side of the main extension section.

In the above heat dissipation structure of tablet display member, the backlight module is composed of light guide plate attached to the backside of the panel and the light source assembly at least partially disposed proximately on a periphery of the light guide plate.

In the above heat dissipation structure of tablet display member, the branch sections obliquely extend in a direction away from the light source assembly and the main extension section.

In the above heat dissipation structure of tablet display member, an electroconductive adhesive layer is disposed between the heat spreader and the heat conduction plate assembly.

In the above heat dissipation structure of tablet display member, the heat conduction plate assembly is disposed in a space defined between a screen frame and a screen backboard. The heat conduction plate assembly has a contact face adjacent to the screen backboard.

In the above heat dissipation structure of tablet display member, the contact face of the heat conduction plate assembly is in contact with an inner surface of the screen backboard. An electroconductive adhesive layer is disposed between the contact face and the inner surface of the screen backboard.

In the above heat dissipation structure of tablet display member, the heat conduction plate assembly is disposed in the screen backboard and at least partially arranged on a periphery of the screen backboard. The heat conduction plate assembly is bent according to the configuration of the periphery of the screen backboard.

In the above heat dissipation structure of tablet display member, the light source assembly is in contact with the heat conduction face of the heat conduction plate assembly.

In the above heat dissipation structure of tablet display member, the light source assembly includes multiple light sources arranged at intervals. The light sources are light-emitting diodes.

The present invention can be best understood through the following description and accompanying drawings, wherein:

### BRIEF DESCRIPTION OF THE DRAWINGS

FIG. 1 is a perspective exploded view of a first embodiment of the present invention;

FIG. 2 is a perspective partially assembled view of the first embodiment of the present invention;

FIG. 3 is a perspective assembled view of the first embodiment of the present invention;

FIG. 4 is a sectional assembled view of the first embodiment of the present invention;

FIG. 5 is a perspective partially assembled view of a second embodiment of the present invention;

FIG. 6 is a perspective partially assembled view of a third embodiment of the present invention;

FIG. 7 is a perspective partially assembled view of a fourth embodiment of the present invention;

FIG. 8 is a sectional assembled view of the fourth embodiment of the present invention;

FIG. 9 is a perspective partially assembled view of a fifth embodiment of the present invention; and

FIG. 10 is a perspective partially assembled view of a sixth embodiment of the present invention.

### DETAILED DESCRIPTION OF THE PREFERRED EMBODIMENTS

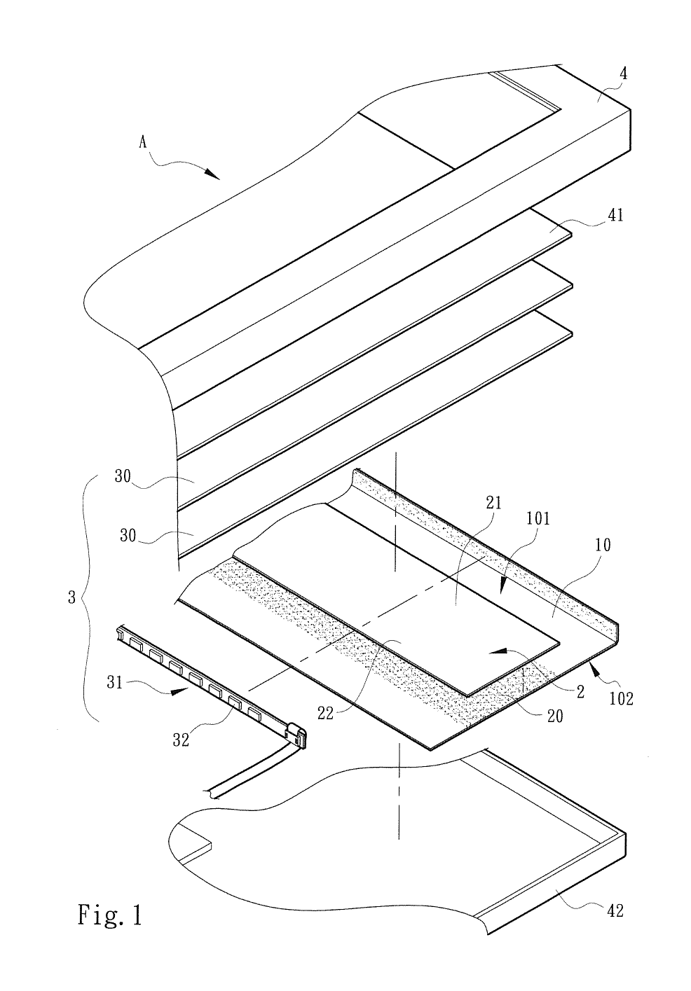

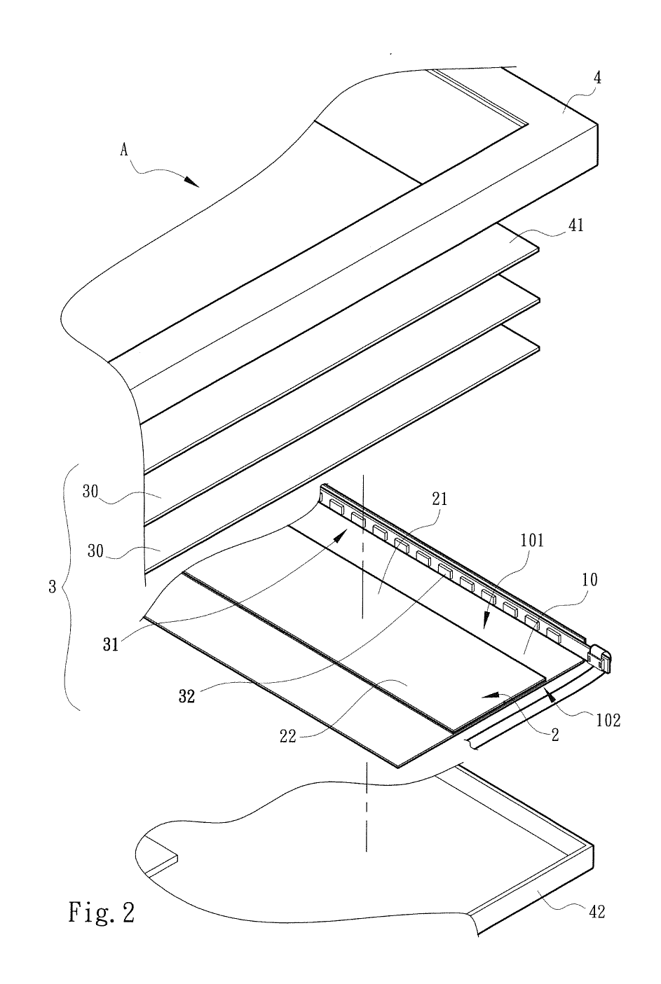

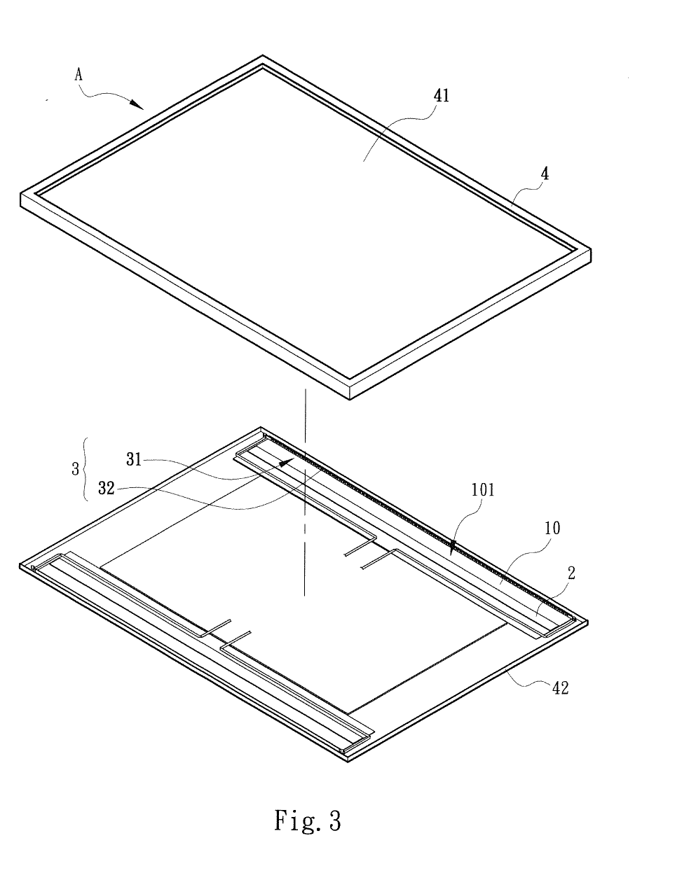

Please refer to FIGS. 1 to 3. According to a first embodiment, the heat dissipation structure of tablet display member of the present invention includes a heat conduction plate assembly 10 and a heat spreader 2. The heat conduction plate assembly 10 is one single heat conduction plate (made of metal material) with electroconductivity. Two faces of the heat conduction plate (heat conduction plate assembly 10) are respectively provided with a contact face 101 and a heat conduction face 102. The heat conduction plate assembly 10 is applicable to a (liquid crystal) screen A. In this embodiment, the screen A is composed of a panel 41 and a backlight module 3. The panel 41 is disposed in a screen frame 4. The backlight module 3 is attached to a backside of the panel 41. A screen backboard 42 is disposed on the other side of the backlight module 3 and connected with the screen frame 4. The backlight module 3 is composed of at least one light guide plate 30 attached to the backside of the panel 41 and a light source assembly 31 at least partially disposed on a periphery of the light guide plate 30. The light source assembly 31 includes multiple light sources 32 arranged at intervals. The heat conduction plate assembly 10 can be bent according to the configuration of the periphery of the screen backboard 42. The heat conduction face 101 of the heat conduction plate (heat conduction plate assembly 10) is partially adjacent to (or in contact with) the light source assembly 31. The contact face 102 is in contact with an inner surface of the screen backboard 42. An electroconductive adhesive layer is disposed between the contact face 102 and the screen backboard 42, whereby the heat conduction plate assembly 10 can be grounded via the screen backboard 42.

The heat spreader 2 is a plate-shaped structure body with an area smaller than that of the heat conduction plate assembly 10 (heat conduction plate). The heat spreader 2 can be made of graphite or the like material. In this embodiment, the heat spreader 2 is an elongated plate body, which has a property of quickly conducting heat along the surface (transversely). The heat spreader 2 is attached to and in contact with the heat conduction plate assembly 10 (heat conduction plate). In practice, the heat spreader 2 can be an electrical conductor. An electroconductive adhesive layer 20 can be disposed between the heat spreader 2 and the heat conduction plate assembly 10 (heat conduction plate) as necessary, whereby the heat spreader 2 and the heat conduction plate assembly 10 (heat conduction plate) are electrically connected with each other. The heat spreader 2 has a proximal-to-heat-source section 21 proximal to the light source assembly 31 and a distal-from-heat-source section 22 distal from the light source assembly 31.

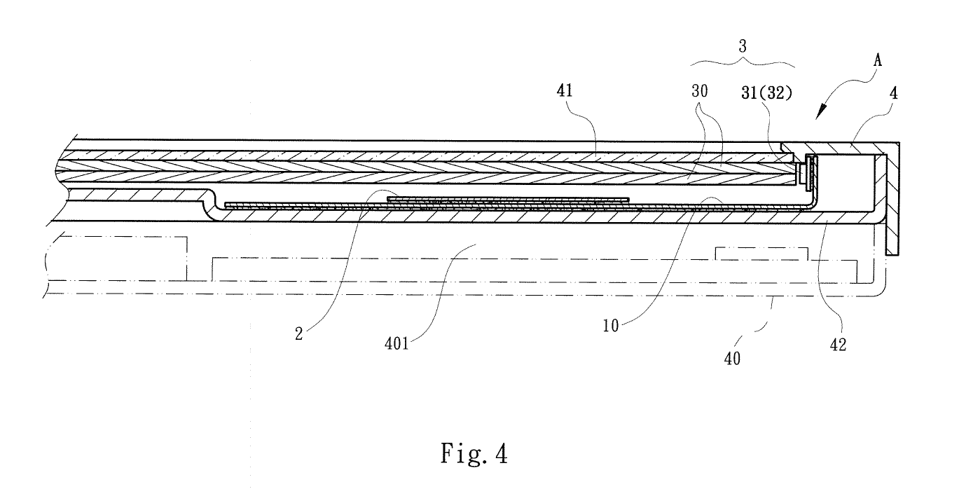

In practice, as shown in FIG. 4, the screen A is connected to a case 40 of an electronic product. A receiving space 401 is defined between the case 40 and the screen A for receiving other electronic components.

In use, the heat generated by the light sources 32 of the light source assembly 31 is partially conducted from the heat conduction face 101 to the heat conduction plate assembly 10 (heat conduction plate). The rest (most) of the heat is directly transferred to the heat spreader 2. Due to the property of quickly conducting heat along the surface (transversely) of the heat spreader 2, the heat is quickly spread from the proximal-to-heat-source section 21 proximal to the light source assembly 31 to the distal-from-heat-source section 22 distal from the light source assembly 31. Then the heat is conducted from the heat spreader 2 to the heat conduction plate assembly 10 (heat conduction plate) and transferred from the contact face 102 of the heat conduction plate assembly 10 (heat conduction plate) to the screen backboard 42. Accordingly, the heat of the light source assembly 31 can be outward dissipated from the heat conduction plate assembly 10 (heat conduction plate) without accumulating around the light source assembly 31. In this case, the temperature of the outer surface of the screen frame 4 will not locally abnormally rise.

In the above heat dissipation structure of the present invention, an adhesive layer can be also disposed between the inner surface of the screen frame 4 and the contact face 102 of the heat conduction plate assembly 10 (heat conduction plate) as necessary. Preferably, the adhesive layer is electroconductive, whereby the heat conduction plate assembly 10 (heat conduction plate) and the screen frame 4 can be more securely and tightly electrically connected with each other for grounding or other purposes. In this embodiment, the heat spreader 2 is disposed on one side of the heat conduction face 101 of the heat conduction plate assembly 10 (heat conduction plate), which face is proximal to the light source assembly 31. However, in practice, as necessary, the heat spreader 2 can be positioned in direct contact with the light source assembly 31. (That is, the heat spreader 2 has a heat conduction face on one side that is proximal to the light source assembly 31). Alternatively, the heat spreader 2 can be disposed on one side of the contact face 102 of the heat conduction plate assembly 10 (heat conduction plate), which face is distal from the light source assembly 31 in direct contact with the inner surface of the screen backboard 42. This can achieve the same heat dissipation effect.

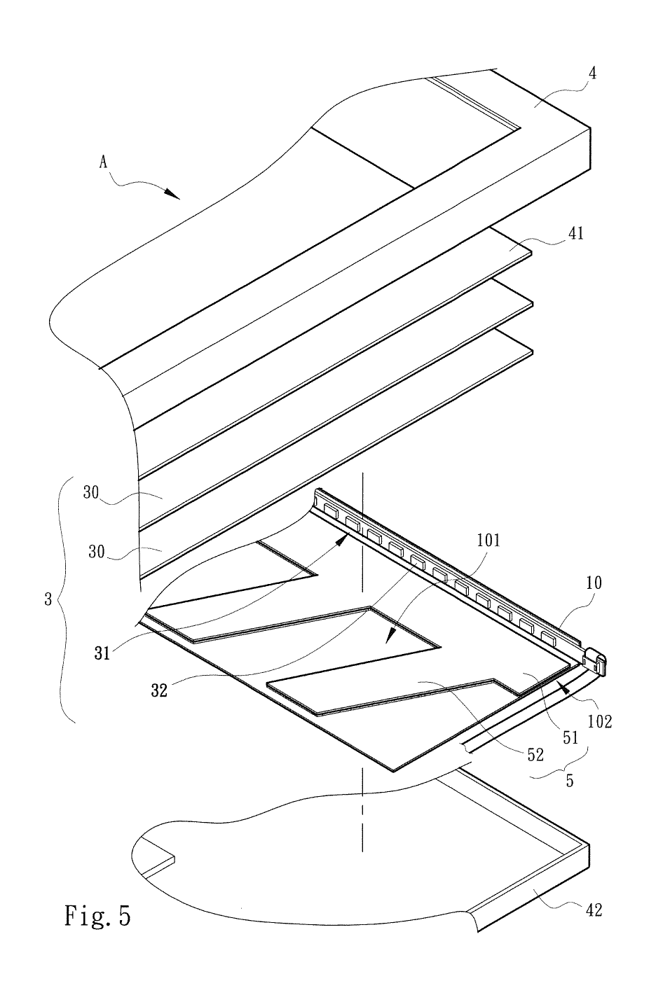

Please now refer to FIG. 5, which shows a second embodiment of the present invention. The second embodiment includes a heat spreader 5 and a heat conduction plate assembly 10 identical to that of the first embodiment. As in the first embodiment, the heat conduction plate assembly 10 is assembled on the inner surface of the screen frame 4. The heat spreader 5 is a plate-shaped structure body disposed on one side of the heat conduction plate assembly 10 (heat conduction plate). An electroconductive adhesive layer can be disposed between the heat conduction plate assembly 10 (heat conduction plate) and the heat spreader 5 as necessary. The heat spreader 5 has an elongated main extension section 51 and multiple branch sections 52 obliquely extending from one side of the main extension section 51 in parallel to each other. The branch sections 52 obliquely extend in a direction away from the light source assembly 31 and the main extension section 51.

In use, the heat generated by the light source assembly 31 is partially conducted from the heat conduction face 101 to the heat conduction plate assembly 10 (heat conduction plate). The rest (most) of the heat is directly transferred to the heat spreader 5. The heat spreader 5 then quickly spreads the heat to those sections that are distal from the light source assembly 31 (to the free ends of the branch sections 52). Then the heat is conducted from the heat spreader 5 to the heat conduction plate assembly 10 (heat conduction plate) and transferred from the contact face 102 of the heat conduction plate assembly 10 (heat conduction plate) to the screen backboard 42. Accordingly, the heat of the light source assembly 31 can be outward dissipated from the heat conduction plate assembly 10 (heat conduction plate) without accumulating around the light source assembly 31.

In practice, the heat spreader 5 can be disposed on one side of the heat conduction plate assembly 10 (heat conduction plate), which side is distal from the light source assembly 31 or disposed on one side of the heat conduction plate assembly 10 (heat conduction plate), which side is proximal to the light source assembly 31. Both can achieve the same heat dissipation effect.

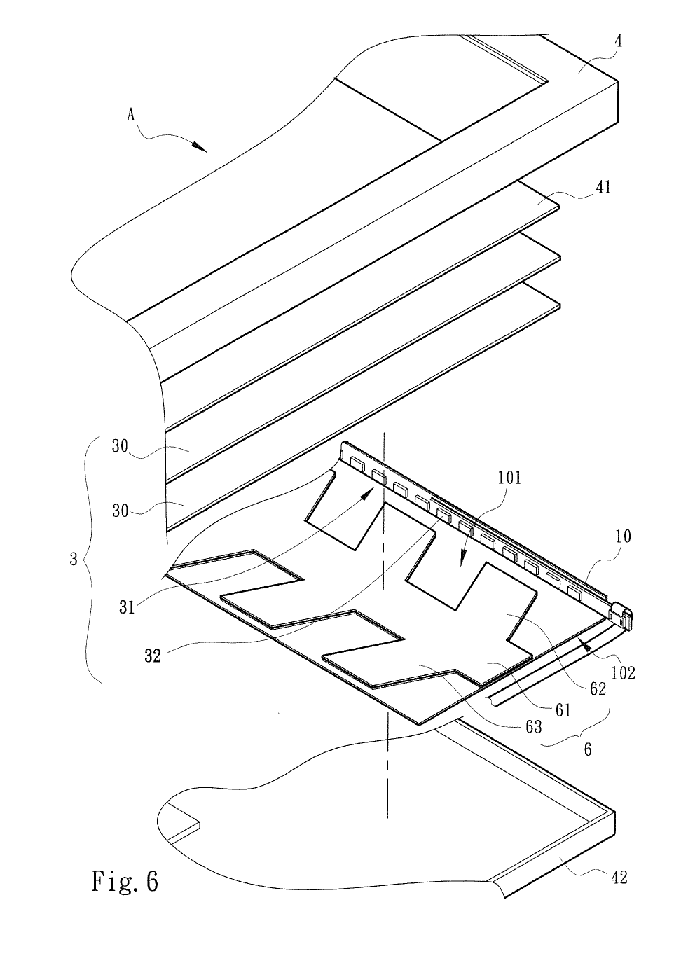

Please now refer to FIG. 6, which shows a third embodiment of the present invention. The third embodiment includes a heat spreader 6 and a heat conduction plate assembly 10 identical to that of the first embodiment. As in the first embodiment, the heat conduction plate assembly 10 is assembled on the inner surface of the screen frame 4. The heat spreader 6 is a plate-shaped structure body disposed on one side of the heat conduction plate assembly 10 (heat conduction plate). An electroconductive adhesive layer can be disposed between the heat conduction plate assembly 10 (heat conduction plate) and the heat spreader 6 as necessary. The heat spreader 6 has an elongated main extension section 61 and multiple branch sections 62, 63 obliquely extending from two sides of the main extension section 61 in parallel to each other. The branch sections 62, 63 obliquely extend in a direction away from the light source assembly 31 and the main extension section 61.

In use, the heat generated by the light source assembly 31 is partially conducted from the heat conduction face 101 to the heat conduction plate assembly 10 (heat conduction plate). The rest (most) of the heat is directly transferred to the heat spreader 6. The heat spreader 6 then quickly spreads the heat to those sections that are distal from the light source assembly 31 (to the free ends of the branch sections 62, 63). Then the heat is conducted from the heat spreader 6 to the heat conduction plate assembly 10 (heat conduction plate) and transferred from the contact face 102 of the heat conduction plate assembly 10 (heat conduction plate) to the screen backboard 42. Accordingly, the heat of the light source assembly 31 can be outward dissipated from the heat conduction plate assembly 10 (heat conduction plate) without accumulating around the light source assembly 31.

In practice, the heat spreader 6 can be disposed on one side of the heat conduction plate assembly 10 (heat conduction plate), which side is distal from the light source assembly 31 or disposed on one side of the heat conduction plate assembly 10 (heat conduction plate), which side is proximal to the light source assembly 31. Both can achieve the same heat dissipation effect.

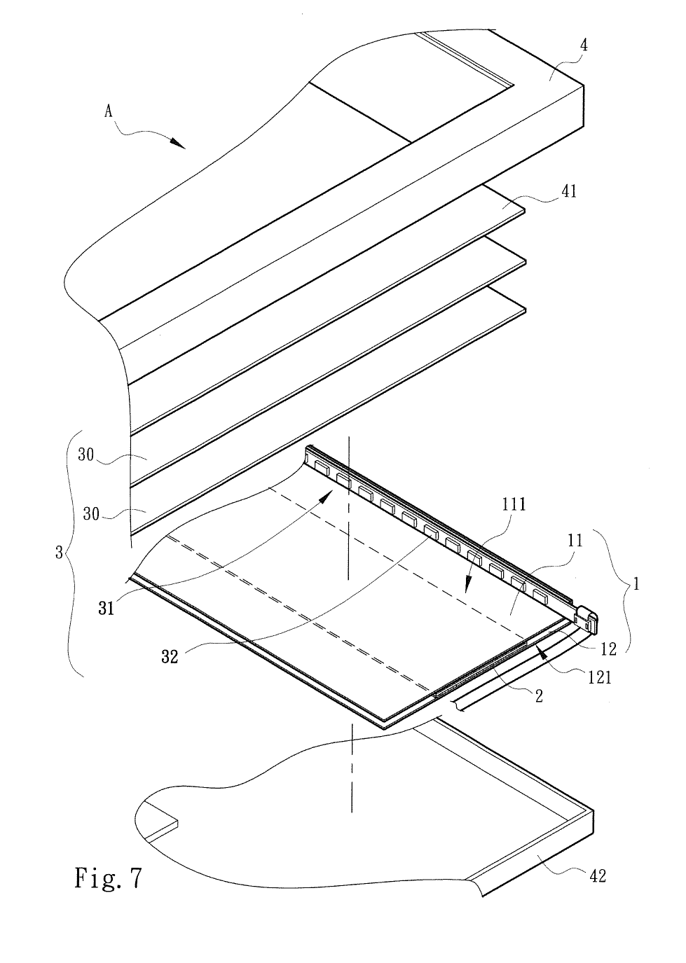

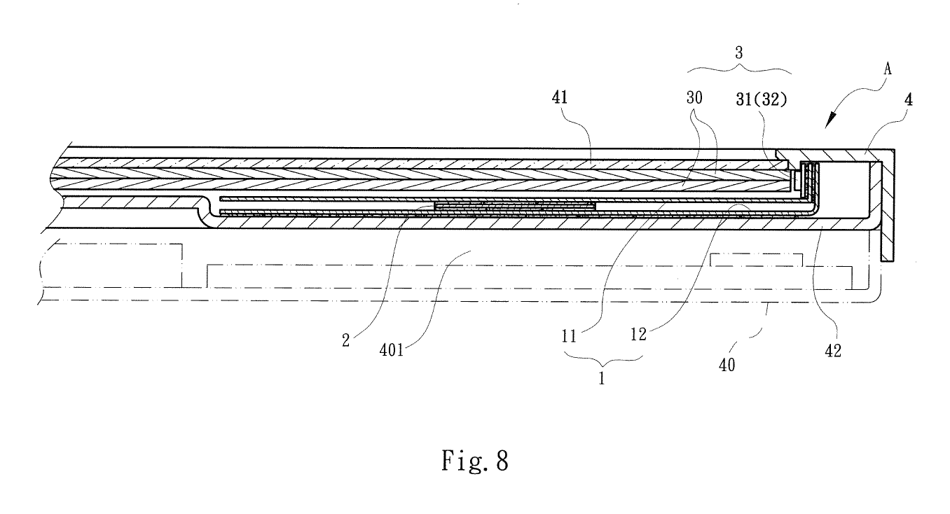

Please now refer to FIGS. 7 and 8, which show a fourth embodiment of the present invention. The fourth embodiment includes a heat conduction plate assembly 1 and a heat spreader 2 identical to that of the first embodiment. The heat conduction plate assembly 1 includes two identical heat conduction plates 11, 12 (made of metal material) with electroconductivity. A contact face 121 is formed on a face of the heat conduction plate 12, which face is distal from the heat conduction plate 11. A heat conduction face 111 is formed on a face of the heat conduction plate 11, which face is distal from the heat conduction plate 12. The heat conduction plate assembly 1 is applicable to a (liquid crystal) screen A. In this embodiment, the screen A is composed of a panel 41 and a backlight module 3. The panel 41 is disposed in a screen frame 4. A screen backboard 42 is disposed on the other side of the backlight module 3 and connected with the screen frame 4. The backlight module 3 is composed of at least one light guide plate 30 attached to the backside of the panel 41 and a light source assembly 31 at least partially disposed proximately on a periphery of the light guide plate 30 and the panel 40. The light source assembly 31 includes multiple light sources 32 arranged at intervals. The heat conduction plate assembly 1 can be bent according to the configuration of the periphery of the screen backboard 42. The heat conduction face 111 of the heat conduction plate assembly 1 is partially adjacent to (or in contact with) the light source assembly 31. The contact face 121 of the heat conduction plate assembly 1 is in contact with (or adjacent to) the inner surface of the screen backboard 42.

The heat spreader 2 is a plate-shaped structure body with an area smaller than that of the heat conduction plate assembly 1 (heat conduction plates 11, 12). The heat spreader 2 can be made of graphite or the like material. The heat spreader 2 is disposed between the heat conduction plates 11, 12 and attached to and in contact with the heat conduction plates 11, 12. In this embodiment, the heat spreader 2 is an elongated plate body, which has a property of quickly conducting heat along the surface (transversely). The heat spreader 2 can be an electrical conductor. Electroconductive adhesive layers 20 can be disposed between the heat spreader 2 and the heat conduction plates 11, 12 as necessary, whereby the heat spreader 2 and the heat conduction plates 11, 12 are electrically connected with each other. The heat spreader 2 has a proximal-to-heat-source section 21 proximal to the light source assembly 31 and a distal-from-heat-source section 22 distal from the light source assembly 31.

In practice, the screen A is connected to a case 40 of an electronic product. A receiving space 401 is defined between the case 40 and the screen A for receiving other electronic components.

In use, the heat generated by the light sources 32 of the light source assembly 31 is partially conducted from the heat conduction face 111 to the heat conduction plate assembly 1 (heat conduction plate 11). The heat conduction plate 11 is made of metal material and is able to uniformly radially spread the heat at equal speed. Therefore, the heat can be quickly transferred through the heat conduction plate 11 to the heat spreader 2. Then, due to the property of quickly conducting heat along the surface (transversely) of the heat spreader 2, the heat is quickly spread from the proximal-to-heat-source section 21 proximal to the light source assembly 31 to the distal-from-heat-source section 22 distal from the light source assembly 31. Then the heat is conducted from the heat spreader 2 to the heat conduction plates 11, 12 and transferred from the contact face 121 to the screen backboard 42. Accordingly, the heat of the light source assembly 31 can be outward dissipated from the heat conduction plates 11, 12 without accumulating around the light source assembly 31. In this case, the temperature of the screen frame 4 will not locally abnormally rise. Also, the heat spreader 2 and the heat conduction plates 11, 12 are electrically connected with each other and grounded via the screen backboard 42.

In the above heat dissipation structure of the present invention, an adhesive layer can be also disposed between the inner surface of the screen frame 4 and the contact face 121 of the heat conduction plate assembly 1 (heat conduction plate 12) as necessary. Preferably, the adhesive layer is electroconductive, whereby the heat conduction plate assembly 1 and the screen frame 4 can be more securely and tightly electrically connected with each other for grounding or other purposes. In this embodiment, the heat spreader 2 is disposed on one side of the heat conduction face 111 of the heat conduction plate assembly 1 (heat conduction plate 11), which face is proximal to the light source assembly 31. However, in practice, alternatively, the heat spreader 2 can be disposed on one side of the contact face 121 of the heat conduction plate assembly 1 (heat conduction plate 12), which face is distal from the light source assembly 31 in direct contact with the inner surface of the screen backboard 42. This can achieve the same heat dissipation effect.

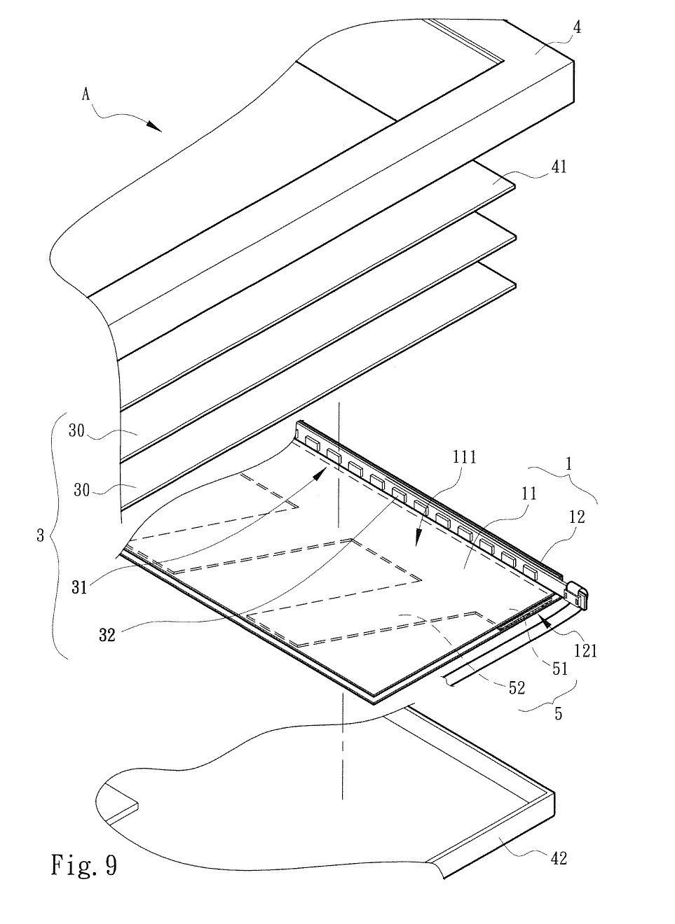

Please now refer to FIG. 9, which show a fifth embodiment of the present invention. The fifth embodiment includes a heat conduction plate assembly 1 and a heat spreader 5 identical to that of the second embodiment. The heat conduction plate assembly 1 includes two heat conduction plates 11, 12 (made of metal material) with electroconductivity. A contact face 121 is formed on a face of the heat conduction plate 12, which face is distal from the heat conduction plate 11. (Alternatively, the contact face can be formed on a face of the heat conduction plate 11, which face is distal from the heat conduction plate 12). In practice, the heat conduction plate assembly 1 is assembled with the inner surface of the screen frame 4 in the same manner. The heat spreader 5 is a plate-shaped structure body disposed between the heat conduction plates 11, 12. (Electroconductive adhesive layers can be disposed between the heat spreader 5 and the heat conduction plates 11, 12 as necessary). The heat spreader 5 has an elongated main extension section 51 and multiple branch sections 52 obliquely extending from one side of the main extension section 51 in parallel to each other. The branch sections 52 obliquely extend in a direction away from the light source assembly 31 and the main extension section 51.

In use, most of the heat generated by the light source assembly 31 is conducted from the heat conduction face 111 to the heat conduction plate 11. The heat can quickly pass through the heat conduction plate 11 and be conducted to the heat spreader 5. The heat spreader 5 then quickly spreads the heat to those sections that are distal from the heat source (to the free ends of the branch sections 52). Then the heat is conducted from the heat spreader 5 to the heat conduction plates 11, 12 to be dissipated outward without accumulating around the light source assembly 31.

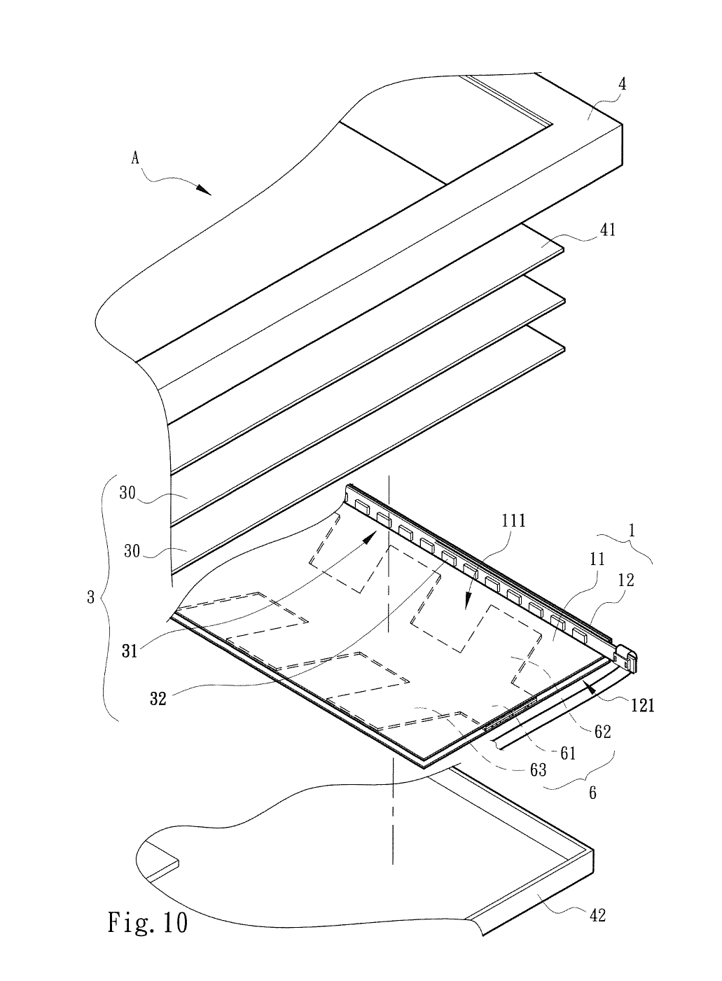

Please now refer to FIG. 10, which shows a sixth embodiment of the present invention. The sixth embodiment includes a heat conduction plate assembly 1 and a heat spreader 6 identical to that of the third embodiment. The heat conduction plate assembly 1 includes two heat conduction plates 11, 12 (made of metal material) with electroconductivity. A contact face 121 is formed on a face of the heat conduction plate 12, which face is distal from the heat conduction plate 11. (Alternatively, the contact face can be formed on a face of the heat conduction plate 11, which face is distal from the heat conduction plate 12). In practice, the heat conduction plate assembly 1 is assembled with the inner surface of the screen frame 4 in the same manner. The heat spreader 6 is a plate-shaped structure body disposed between the heat conduction plates 11, 12. (Electroconductive adhesive layers can be disposed between the heat spreader 6 and the heat conduction plates 11, 12 as necessary). The heat spreader 6 has an elongated main extension section 61 and multiple branch sections 62, 63 obliquely extending from two sides of the main extension section 61 in parallel to each other. The branch sections 62, 63 obliquely extend in a direction away from the light source assembly 31 and the main extension section 61.

In use, most of the heat generated by the light source assembly 31 is conducted from the heat conduction face 111 to the heat conduction plate 11. The heat can quickly pass through the heat conduction plate 11 and be conducted to the heat spreader 6. The heat spreader 6 then quickly spreads the heat to those sections that are distal from the heat source (to the free ends of the branch sections 62). Then the heat is conducted from the heat spreader 6 to the heat conduction plates 11, 12 to be dissipated outward without accumulating around the light source assembly 31.

In conclusion, the heat dissipation structure of tablet display member of the present invention can enhance the heat dissipation efficiency of the display member at lower manufacturing cost so as to avoid abnormal rise of the temperature of a local part of the display member.

The above embodiments are only used to illustrate the present invention, not intended to limit the scope thereof. Many modifications of the above embodiments can be made without departing from the spirit of the present invention.

What is claimed is:

1. A heat dissipation structure of tablet display member, comprising:
at least one backlight module having a light source assembly, the light source assembly being at least partially disposed on a periphery of a panel;
at least one heat conduction plate assembly having at least one electroconductive heat conduction plate; and
at least one heat spreader, which is able to quickly conduct heat along the surface, the heat spreader being attached to and in contact with the heat conduction plate assembly, the heat spreader having a proximal-to-heat-source section proximal to the light source assembly and a distal-from-heat-source section distal from the light source assembly, at least one of the heat conduction plate assembly and the heat spreader having a heat conduction face adjacent to the light source assembly.

2. The heat dissipation structure of tablet display member as claimed in claim 1, wherein the heat conduction plate assembly includes at least two heat conduction plates, the heat spreader being disposed between the heat conduction plates in contact with the heat conduction plates.

3. The heat dissipation structure of tablet display member as claimed in claim 2, wherein the heat conduction plates of the heat conduction plate assembly have equal size and identical shape.

4. The heat dissipation structure of tablet display member as claimed in claim 1, wherein the heat spreader has an area smaller than that of the heat conduction plates.

5. The heat dissipation structure of tablet display member as claimed in claim 2, wherein the heat spreader has an area smaller than that of the heat conduction plates.

6. The heat dissipation structure of tablet display member as claimed in claim 3, wherein the heat spreader has an area smaller than that of the heat conduction plates.

7. The heat dissipation structure of tablet display member as claimed in claim 4, wherein the heat spreader is an elongated plate body.

8. The heat dissipation structure of tablet display member as claimed in claim 5, wherein the heat spreader is an elongated plate body.

9. The heat dissipation structure of tablet display member as claimed in claim 6, wherein the heat spreader is an elongated plate body.

10. The heat dissipation structure of tablet display member as claimed in claim 1, wherein the heat spreader has an elongated main extension section and at least one branch section obliquely extending from at least one side of the main extension section.

11. The heat dissipation structure of tablet display member as claimed in claim 2, wherein the heat spreader has an elongated main extension section and at least one branch section obliquely extending from at least one side of the main extension section.

12. The heat dissipation structure of tablet display member as claimed in claim 3, wherein the heat spreader has an elongated main extension section and at least one branch section obliquely extending from at least one side of the main extension section.

13. The heat dissipation structure of tablet display member as claimed in claim 1, wherein the backlight module is composed of light guide plate attached to the backside of the panel and the light source assembly at least partially disposed proximately on a periphery of the light guide plate.

14. The heat dissipation structure of tablet display member as claimed in claim 2, wherein the backlight module is composed of light guide plate attached to the backside of the panel and the light source assembly at least partially disposed proximately on a periphery of the light guide plate.

15. The heat dissipation structure of tablet display member as claimed in claim 3, wherein the backlight module is composed of light guide plate attached to the backside of the panel and the light source assembly at least partially disposed proximately on a periphery of the light guide plate.

16. The heat dissipation structure of tablet display member as claimed in claim 10, wherein the backlight module is composed of light guide plate attached to the backside of the panel and the light source assembly at least partially disposed proximately on a periphery of the light guide plate.

17. The heat dissipation structure of tablet display member as claimed in claim 10, wherein the branch sections obliquely extend in a direction away from the light source assembly and the main extension section.

18. The heat dissipation structure of tablet display member as claimed in claim 13, wherein the branch sections obliquely extend in a direction away from the light source assembly and the main extension section.

19. The heat dissipation structure of tablet display member as claimed in claim 1, wherein an electroconductive adhesive layer is disposed between the heat spreader and the heat conduction plate assembly.

20. The heat dissipation structure of tablet display member as claimed in claim 4, wherein an electroconductive adhesive layer is disposed between the heat spreader and the heat conduction plate assembly.

21. The heat dissipation structure of tablet display member as claimed in claim 13, wherein an electroconductive adhesive layer is disposed between the heat spreader and the heat conduction plate assembly.

22. The heat dissipation structure of tablet display member as claimed in claim 1, wherein the heat conduction plate assembly is disposed in a space defined between a screen frame and a screen backboard, the heat conduction plate assembly having a contact face adjacent to the screen backboard.

23. The heat dissipation structure of tablet display member as claimed in claim 2, wherein the heat conduction plate assembly is disposed in a space defined between a screen frame and a screen backboard, the heat conduction plate assembly having a contact face adjacent to the screen backboard.

24. The heat dissipation structure of tablet display member as claimed in claim 3, wherein the heat conduction plate assembly is disposed in a space defined between a screen frame and a screen backboard, the heat conduction plate assembly having a contact face adjacent to the screen backboard.

25. The heat dissipation structure of tablet display member as claimed in claim 4, wherein the heat conduction plate assembly is disposed in a space defined between a screen frame and a screen backboard, the heat conduction plate assembly having a contact face adjacent to the screen backboard.

26. The heat dissipation structure of tablet display member as claimed in claim 10, wherein the heat conduction plate assembly is disposed in a space defined between a screen frame and a screen backboard, the heat conduction plate assembly having a contact face adjacent to the screen backboard.

27. The heat dissipation structure of tablet display member as claimed in claim 13, wherein the heat conduction plate assembly is disposed in a space defined between a screen frame and a screen backboard, the heat conduction plate assembly having a contact face adjacent to the screen backboard.

28. The heat dissipation structure of tablet display member as claimed in claim 19, wherein the contact face of the heat conduction plate assembly is in contact with an inner surface of the screen backboard, an electroconductive adhesive layer being disposed between the contact face and the inner surface of the screen backboard.

29. The heat dissipation structure of tablet display member as claimed in claim 22, wherein the contact face of the heat conduction plate assembly is in contact with an inner surface of the screen backboard, an electroconductive adhesive layer being disposed between the contact face and the inner surface of the screen backboard.

30. The heat dissipation structure of tablet display member as claimed in claim 25, wherein the contact face of the heat conduction plate assembly is in contact with an inner surface of the screen backboard, an electroconductive adhesive layer being disposed between the contact face and the inner surface of the screen backboard.

31. The heat dissipation structure of tablet display member as claimed in claim 22, wherein the heat conduction plate assembly is disposed in the screen backboard and at least partially arranged on a periphery of the screen backboard, the heat conduction plate assembly being bent according to the configuration of the periphery of the screen backboard.

32. The heat dissipation structure of tablet display member as claimed in claim 28, wherein the heat conduction plate assembly is disposed in the screen backboard and at least partially arranged on a periphery of the screen backboard, the heat conduction plate assembly being bent according to the configuration of the periphery of the screen backboard.

33. The heat dissipation structure of tablet display member as claimed in claim 1, wherein the light source assembly is in contact with the heat conduction face of the heat conduction plate assembly.

34. The heat dissipation structure of tablet display member as claimed in claim 2, wherein the light source assembly is in contact with the heat conduction face of the heat conduction plate assembly.

35. The heat dissipation structure of tablet display member as claimed in claim 4, wherein the light source assembly is in contact with the heat conduction face of the heat conduction plate assembly.

36. The heat dissipation structure of tablet display member as claimed in claim 10, wherein the light source assembly is in contact with the heat conduction face of the heat conduction plate assembly.

37. The heat dissipation structure of tablet display member as claimed in claim 13, wherein the light source assembly is in contact with the heat conduction face of the heat conduction plate assembly.

38. The heat dissipation structure of tablet display member as claimed in claim 1, wherein the light source assembly includes multiple light sources arranged at intervals, the light sources being light-emitting diodes.

39. The heat dissipation structure of tablet display member as claimed in claim 2, wherein the light source assembly includes multiple light sources arranged at intervals, the light sources being light-emitting diodes.

40. The heat dissipation structure of tablet display member as claimed in claim 4, wherein the light source assembly includes multiple light sources arranged at intervals, the light sources being light-emitting diodes.

41. The heat dissipation structure of tablet display member as claimed in claim 10, wherein the light source assembly includes multiple light sources arranged at intervals, the light sources being light-emitting diodes.

42. The heat dissipation structure of tablet display member as claimed in claim 13, wherein the light source assembly includes multiple light sources arranged at intervals, the light sources being light-emitting diodes.

43. The heat dissipation structure of tablet display member as claimed in claim 22, wherein the light source assembly includes multiple light sources arranged at intervals, the light sources being light-emitting diodes.

44. The heat dissipation structure of tablet display member as claimed in claim 33, wherein the light source assembly includes multiple light sources arranged at intervals, the light sources being light-emitting diodes.
